(19) United States
(12) Patent Application Publication
(10) Pub. No.: US 2005/0257915 A1
(43) Pub. Date: Nov. 24, 2005

(54) Cooling device

(75) Inventor: Stefan Wellhofer, Sommerda (DE)

Correspondence Address: JANSSON, SHUPE & MUNGER & ANTARAMIAN, LTD, 245 MAIN STREET, RACINE, WI, 53403, US

(73) Assignee: Innowert GmbH

(21) Appl. No.: 11/131,629

(22) Filed: May 18, 2005

(30) Foreign Application Priority Data
May 18, 2004 (EP) 04 011 767.3

(51) Int. Cl. B01D 8/00; F28D 15/00

(52) U.S. Cl. 165/104.21

(57) ABSTRACT

The invention relates to a cooling device (1) with a plurality of evaporation chambers (10) being positioned adjacently and having one open side and boundary walls (11) of a thermally conductive material, on the inner surfaces (13) of which a fleece (15) soaked with a liquid is arranged, and the outer surfaces (12) of said walls being suitable for being contacted with a material to be cooled. The cooling device further comprises, corresponding to the number of evaporation chambers (10), a plurality of adjacently positioned condensation chambers (20), having one open side and boundary walls (21) of a thermally conductive material, which are suitable for dissipating heat to the ambient environment through their outer surfaces (22). Each evaporation chamber (10) is in communication with a predetermined condensation chamber (20) via their open sides such that a gas-tight sealed, partially evacuated spatial section (3) is formed between the evaporation chamber (10) and condensation chamber (20), so that in operation the liquid contained in the fleece (15) of an evaporation chamber (10) evaporates in the spatial section (3), condenses on the inner surface (23) of the corresponding condensation chamber (20) and is passed again to the fleece (15). The boundary walls (11) of the evaporation chambers (10) and the boundary walls (21) of the condensation chambers (20) are thermally and electrically decoupled from one another by suitable plastic elements (5).

### RELATED APPLICATION

This application claims the benefit of EP 04 011 767.3, filed on May 18, 2004, the contents of which is incorporated herein.

### FIELD OF THE INVENTION

The invention relates to a cooling device for preferably large-format units which are to be cooled and which have a high thermal dissipation.

### BACKGROUND OF THE INVENTION

Due to the substantially increasing use of electrical or electronic devices, both in industry and also in many fields of daily life, there is a high demand for cooling devices. This also applies to a significant extent to the outdoor sector, where to date active cooling devices, such as fans, have been employed. In operation they cause unwanted noise and when failing they can very quickly lead to overheating of and damage to the unit to be cooled.

In particular with large-format units to be cooled, the assembly and operation of active cooling devices, which provide the required large cooling effect, is associated with high costs.

The use of heat pipes as cooling devices, where aprofiled heat sink dissipates heat due to the evaporation of liquid and its condensation, is generally known. Conventional heat pipes are however not suitable for large-format applications, because the paths from the evaporation surface to the condensation surface are relatively long. The use of a number of heat pipes on a large-format unit to be cooled is expensive and unsuitable due to the limited amount of heat that can be dissipated.

It is therefore the object of this invention to provide a cooling device for large-format units to be cooled which has a high efficiency, is versatile in use and is very simple and economical in its manufacture and application.

### SUMMARY OF THE INVENTION

According to the invention a cooling device is provided, which comprises a plurality of evaporation chambers being positioned adjacently and having one open side and boundary walls of a thermally conductive material, on the inner surfaces of which a fleece soaked with a liquid is arranged, and the outer surfaces ofthe boundary walls being suitable for being contacted with a material to be cooled. The cooling device further comprises a plurality, corresponding to the number of evaporation chambers, of adjacently positioned condensation chambers having one open side and boundary walls of a thermally conductive material, which are suitable for dissipating heat to the ambient environment through their outer surfaces, wherein each evaporation chamber is in communication with a predefined condensation chamber via their open sides such that a gas-tight closed, partially evacuated spatial section is formed between the evaporation and condensation chambers, so that in operation the liquid contained in the fleece of an evaporation chamber evaporates in the spatial section, condenses on the inner surfaces of the corresponding condensation chamber and is passed again to the fleece, wherein the boundary walls of the evaporation chamber and the boundary walls of the condensation chamber are thermally and electrically decoupled from one another by suitable plastic elements.

A cooling device ofthis type according to the invention now also facilitates even large amounts of heat to be dissipated in short time due to the short path from the evaporation surface to the condensation surface. In this way the evaporation surfaces and the condensation surfaces can be formed as large as required and can be optimised for the appropriate use. Due to the electrical and thermal decoupling of the evaporation and condensation surfaces, the resistance against thermal transfer of the cooling device according to the invention is very low. A use outdoors is possible, and the cooling of elements supplied with high voltage can also be performed.

Advantageously, a metal gauze is arranged on the inner surfaces of the condensation chambers. Consequently, the condensed liquid is picked up and the efficiency of the cooling device is increased. Also, due to the capillary effect, the cooling device can be used in any orientation.

Preferably, the boundary walls and connecting webs ofthe evaporation chambers and condensation chambers are formed of one piece as an extruded profile. In particular, one advantage of this invention is that the profile is formed such that the evaporation and condensation chambers have a U-shaped cross-section and are arranged adjacently connected via intermediatelypositioned connecting webs. Consequently, cooling systems of the type according to the invention can be manufactured very simply and economically and offer versatile design and adaptation options.

Advantageously, the spatial sections formed by the evaporation and condensation chambers are closed in a gas-tight manner at their sides with covering elements. In particular it is an advantage that the covering elements are formed from polyurethane. These types of plastic covering elements are simple and inexpensive to manufacture and offer very good properties for maintaining the vacuum as they contract under a vacuum, giving additional sealing.

The cooling device according to the invention preferably comprises plastic elements as sealing strips arranged between the profiles, ensuring thermal and electrical decoupling of the evaporation and condensation chambers.

To increase the thermal dissipation the liquid located in the spatial sections is preferably alcohol or distilled water.

Preferably, the outer surfaces of the condensation chambers have enlarged surfaces. This substantially increases the thermal dissipation of the cooling system.

Preferably, each condensation chamber is positioned above the corresponding evaporation chamber, whereby condensed liquid is quickly passed to the fleece, ensuring a continuously high thermal dissipation.

Further details, advantages and features of this invention are given by the following description with reference to the enclosed drawings.

### DESCRIPTION OF THE DRAWINGS

FIG. 1 shows a cross-sectional view of a first embodiment ofthe cooling device according to the invention;

FIG. 2 shows an exploded illustration of the cooling device in FIG. 1;

FIG. 3 shows a cross-sectional view of a second embodiment of the cooling device according to the invention; and

FIG. 4 shows an exploded illustration of the cooling device in FIG. 3.

### DETAILED DESCRIPTION OF PREFERRED EMBODIMENTS

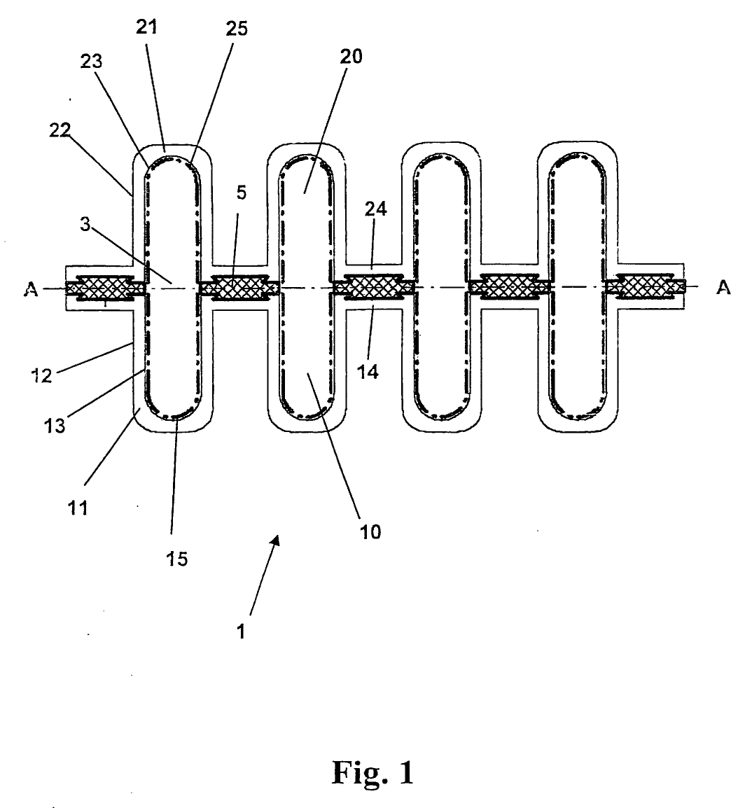

FIG. 1 shows a first preferred embodiment of this invention, wherein the cooling device 1 is illustrated in cross-section and there is symmetry with regard to the plane defined by A-A. In the lower half the cooling device 1 comprises four evaporation chambers 10 which are confined by the boundary walls 11 which are joined together in each case byjoining webs 14. The outer surfaces 12 of the evaporation chambers 10 are in thermal contact with the unit to be cooled (not shown). On the inner surfaces 13 of the evaporation chambers 10 a fleece 15 is arranged which is soaked with a liquid, such as for example distilled water or alcohol.

In the upper half the cooling device 1 comprises four condensation chambers 20 which are confined by the boundary walls 21 which are in turn joined together in each case by connecting webs 24. The outer surfaces 22 of the condensation chambers 20 are suitable for dissipating heat into their surroundings. On the inner surfaces 23 of the condensation chambers 20 a gauze 25, preferably formed of metal, is arranged, which serves to pick up the condensed liquid and to feed it back to the fleece 15 in the evaporation chamber. The use of the gauze 25 is practicable due to the capillary effect, because the cooling device can also, for example, operate upside down, but this is not necessary for the function of the cooling device according to the invention. Also, the gauze 25 prevents drops of condensed liquid from falling back directly into the evaporation chambers 10. The one-side openings of the evaporation chambers 10 and of the condensation chambers 20 are in the plane A-A essentially positioned opposite one another, whereby a spatial section 3, which is evacuated, is created in each case consisting of one evaporation chamber 10 and one condensation chamber 20. The boundarywalls 11, 21 and connectingwebs 14, 24 ofthe adjacent evaporation chambers 10 and condensation chambers 20 are formed of a profile which in cross-section is preferably U-shaped or cartridge-shaped and which in the preferred embodiment is manufactured from extruded aluminium.

The evaporation profile of the lower half is spaced at a predetermined distance from the condensation profile of the upper half, wherein this distance is determined by the thickness of the plastic elements 5, which are located between the connecting webs 14, 24. The evaporation chambers 10 and the condensation chambers 20 are thermally and electrically decoupled from one another by the plastic elements 5. For the material of the plastic elements 5, plastics with suitable thermal and electrical properties can be used. Of course, besides aluminium other metals or other thermally conductive materials can be used for the evaporation and condensation profiles.

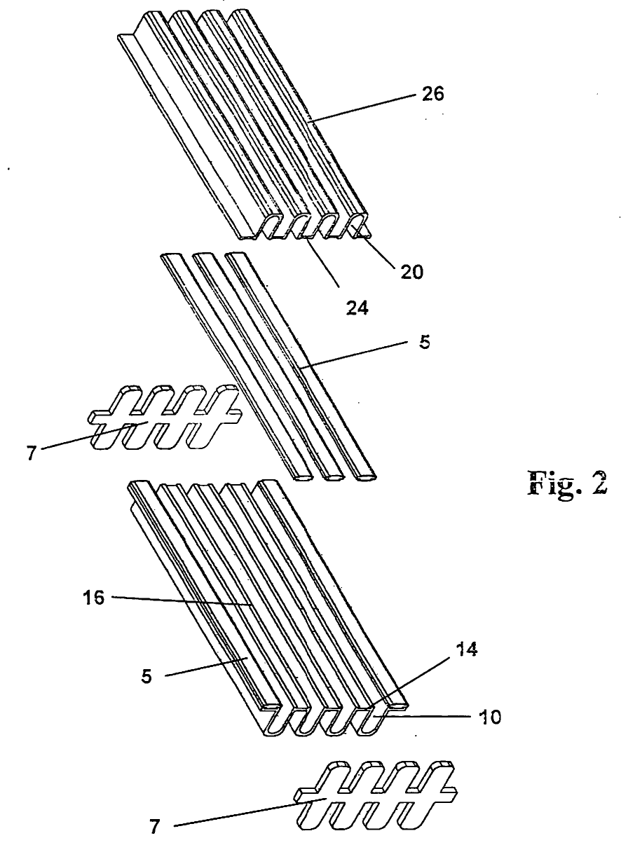

The principal components of the cooling device according to the invention in FIG. 1 are illustrated in an exploded view in FIG. 2 using the same reference symbols. The profiles 16, 26 are arranged one above the other, wherein the plastic elements 5 are positioned between the connecting webs 14, 24. The connecting webs 14, 24 can for example be formed such that the plastic elements 5 can be pushed in as if they were rail-guided, wherein a gas-tight joint is created between the two profiles 16, 26 which is resistant to tension. The profiles 16, 26 connected firmly together in this way are closed off at the sides with the covering elements 7. These covering elements 7 are preferably produced of polyurethane plastic which deforms in a direction to produce even better sealing, when the spatial sections are (partially) evacuated by using vacuum pumps, which are as such known.

With the preferred embodiment ofthe cooling device 1 according to the invention illustrated in FIG. 1 and FIG. 2 the evaporation and condensation chambers 10, 20 are positioned vertically. Use of this embodiment of the cooling device 1 with a non-vertical arrangement is, of course, also possible, although this slightly reduces the efficiency of the cooling device.

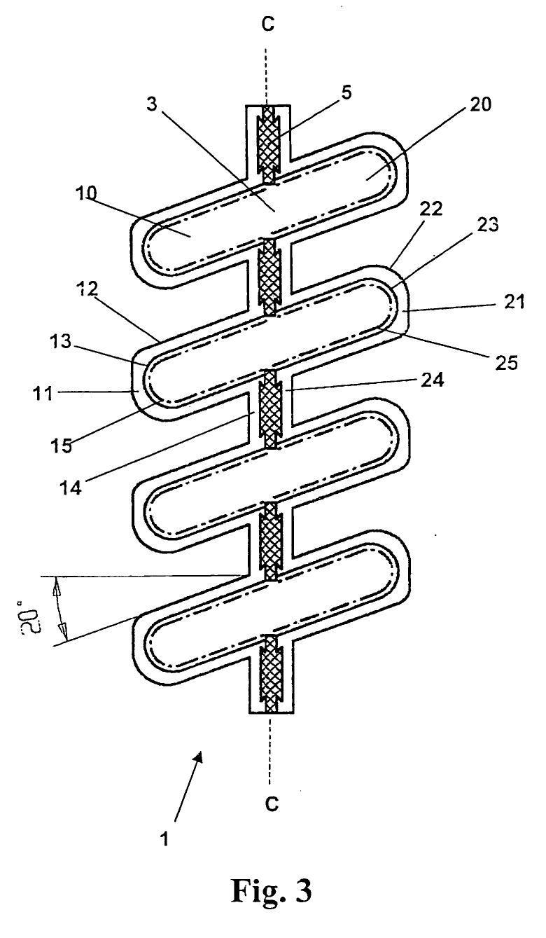

FIG. 3 shows a second preferred embodiment of the cooling device 1 according to the invention in which the evaporation chambers 10 and condensation chambers 20 are not arranged symmetrically with reference to the plane defined by C-C. In the example illustrated here the evaporation chambers 10 or condensation chambers 20 are arranged at 20° with respect to a plane perpendicular to the plane C-C, pointing diagonally downwards, respectively diagonally upwards and being parallel to one another. Of course, with this embodiment also other inclination angles can be selected. A particular advantage of this embodiment is that with tilting the complete cooling device 1 in the plane defined by C-C chimney-type air shafts can be formed between the condensation chambers 20, increasing the cooling capacity of the cooling device.

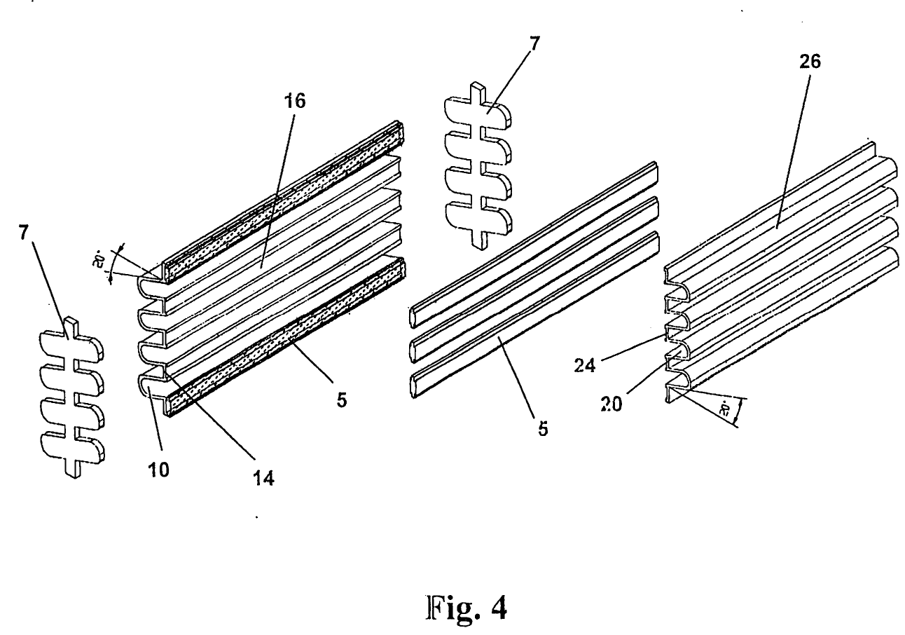

FIG. 4 shows an exploded view ofthe principal components ofthe cooling device according to the invention in FIG. 3. The reference symbols of FIG. 2 are used.

In the following the cooling process according to the invention is explained. First, the boundary walls 11 ofthe evaporation chambers 10 heat up, because the outer surfaces 12 are in contact with the medium to be cooled, e.g. hot gas or the unit to be cooled, e.g. an electronic component. The boundary walls 11 of the evaporation chambers 10 consist of a material having high thermal conductivity and the liquid contained in the fleece 15 evaporates in the partially evacuated spatial section 3 even at relatively low temperatures, because its boiling temperature is reduced due to the vacuum. Due to the temperature difference, the liquid vapour migrates in the direction of the condensation chambers 20, diffuses through the gauze 25 and condenses on the inner wall 23 of the condensation chambers 20. As aresult, heat is dissipated on the boundary walls 21 ofthe condensation chambers 20 which is transferred to the ambient environment via the outer wall 22 ofthe condensation chamber 20. The cooled, condensed liquid again returns on the inner wall 23 or the metal gauze 25 in the direction of the evaporation chambers 10 and is again passed to the fleece 15.

This thermal transfer mechanism via evaporated liquid is extremely effective, primarily because the paths from the evaporation surface to the condensation surface are very short. Furthermore, there is the advantage that relatively low temperatures prevail in the cooling device. In this way substantial amounts of heat can be dissipated in short time. Moreover, the cooling device according to the invention can be designed such that the evaporation and condensation surfaces are as large as required. In comparison to conventional cooling devices, which function according to the heat-pipe principle, the subject of this invention exhibits a substantially higher efficiency. This high efficiency as well as the electrical and thermal decoupling of the evaporation and condensation surfaces results in the resistance of the cooling system against heat transfer being very low.

Due to the suggested use of extruded profiles and plastic moulded parts, the manufacture of cooling devices according to the invention is very simple and economical.

Consequently, a cooling device is produced which effectively cools even large-format units, which can be used in the most varied environments such as for example outdoors, which exhibits a high efficiency, i.e. can provide high thermal dissipation, and can be produced simply and quite economically. Of course, this principle of a passive cooling device for large surfaces is not restricted to the exact embodiment as revealed in the description above.

Finally, it is also conceivable for the arrangement of the evaporation and condensation chambers 10, 20, that they are not arranged parallel to one another, but for example concentrically, i.e. in an annular shape or also irregularly adjacent.

Overall, the cooling device according to the invention can be flexibly adapted to a large number of external conditions. A solution is thus provided, which can dissipate heat effectively, which functions in an environmentally friendly manner and does not require any maintenance.

1. A cooling device comprising:
a plurality of evaporation chambers positioned adjacently to one another and each evaporation chamber having one open side and boundary walls of a thermally conductive material, the boundary walls having inner surfaces on which a fleece soaked with a liquid is arranged, and the boundary wall further having an outer surface suitable for being contacted with a material to be cooled, and,
corresponding to the number of evaporation chambers, a plurality of adjacently positioned condensation chambers, having one open side and boundary walls of a thermally conductive material, the boundary walls being suitable for dissipating heat to the ambient environment through an outer surface thereof,
wherein each evaporation chamber is in communication with a predetermined condensation chamber via their open sides such that a gas-tight sealed, partially evacuated spatial section is formed between the evaporation chamber and condensation chamber, so that in operation the liquid contained in the fleece of an evaporation chamber evaporates in the spatial section, condenses on an inner surface of the corresponding condensation chamber and is passed again to the fleece, and
wherein the boundary walls of the evaporation chambers and the boundary walls of the condensation chambers are thermally and electrically decoupled from one another by suitable plastic elements.

2. The cooling device according to claim 1, wherein the evaporation cambers and the condensation chambers have a profile including a U-shaped cross-section with connecting webs between adjacent chambers of the same kind.

3. The cooling device according to claim 1, characterised in that the spatial sections are closed in gas-tight manner at their sides with covering elements.

3. The cooling device according to claim 1, characterised in that the spatial sections are closed in gas-tight manner at their sides with covering elements.

4. The cooling device according to claim 1, wherein the plastic elements are formed as sealing strips arranged between the profiles.

5. The cooling device according to claim 1, wherein the liquid is alcohol or distilled water.

6. The cooling device according to claim 1, wherein each condensation chamber is arranged above the corresponding evaporation chamber.

7. The cooling device according to claim 6, wherein the evaporation cambers and the condensation chambers have a profile including a U-shaped cross-section with connecting webs between adjacent chambers of the same kind.

8. The cooling device according to claim 6, wherein the spatial sections are closed in gas-tight manner at their sides with covering elements.

9. The cooling device according to claim 6, wherein the plastic elements are formed as sealing strips arranged between the profiles.

10. The cooling device according to claim 6,wherein the liquid is alcohol or distilled water.
